(19) United States
(12) Patent Application Publication
(10) Pub. No.: US 2021/0133005 A1
(43) Pub. Date: May 6, 2021

(54) OPERATING SYSTEM FOR A SENSOR OF A SENSOR NETWORK AND ASSOCIATED SENSOR

(71) Applicants: Université Clermont Auvergne, CLERMONT FERRAND (FR); Centre national de la reccerche scientifique, PARIS (FR)

(72) Inventors: Kun Mean HOU, CLERMONT FERRAND (FR); Christophe DE VAULX, AUBIERE CEDEX (FR); Xunxing DIAO, AUBIERE CEDEX (FR); Hongling SHI, AUBIERE CEDEX (FR)

(21) Appl. No.: 15/998,722

(22) PCT Filed: Feb. 16, 2017
(86) PCT No.: PCT/EP2017/053459

§ 371 Date: Aug. 16, 2018

(30) Foreign Application Priority Data
Feb. 16, 2016 (FR) 16 51233

(51) Int. Cl. G06F 9/54; G06F 11/34; G06F 11/07

(52) U.S. Cl. CPC G06F 9/54; G06F 11/0721; G06F 11/0793; G06F 11/3495

(57) ABSTRACT

This operating system (101) for a sensor of sensor network is configured in a manner which comprises, in addition to a plurality of generic system functionalities for virtualisation of hardware resources of the sensor, comprising in particular radio-communication functionalities (112) and routing functionalities (114), a plurality of application functionalities (122), each functionality being defined by a software actor (124, 126), each software actor consisting of a finite state automaton, the execution of the various actors being defined in a predetermined scheduling sequence determining the temporal order of the call up of each actor during the course of an execution cycle.

The present invention pertains to the technical field of operating systems dedicated to sensors constituting the nodes of a sensor network.

The Internet of Things, or Web of Things, is an extension of the current Internet aiming at exchanging information and data between the Internet and devices present in the physical environment.

Among the devices whose connection to the Internet would be of industrial interest, there are networks of sensors, comprising a plurality of sensors, for example between a few tens and a few hundred sensors, placed in the environment for the acquisition of measurements. For example, it can be a network of sensors distributed on a farm, in order to collect a set of geo-localized measurements that are relevant for the management of the farm: temperature, humidity and pH of the soil, humidity of the air, wind speed, UV index, etc.

Such a sensor is intelligent in that it comprises a storage means, such as a memory, a calculation means, such as a processor, an input/output interface for connecting to one or more detector, and a network interface for the connection, for example by means of a wireless connection of the Wi-Fi, IEEE 802.15.4, NB-IoT (Narrow Band Internet of Things) or 3G/4G type, to the other nodes of the network and the Internet. In particular, the sensor memory comprises computer program instructions suitable for being executed by the processor.

In addition, such a sensor is autonomous in that it comprises power supply means, such as a battery, for the operation of the sensor.

However, such a connected device has only limited computing capacity and information storage, essentially allowing the acquisition of measurements and the performance of simple processing on these raw measurements, and the transmission of the processed measurements to a base station connected to the Internet.

In addition, each sensor network is implemented for a particular purpose.

Each sensor of a network is therefore developed specifically for the intended use.

Finally, the sensors of a network have to be distributed in the environment. Accordingly, it is imperative that they require only low maintenance. They must therefore have considerable autonomy and reliability.

It is therefore necessary to provide these sensors with an operating system to virtualize the hardware layer of a generic sensor and therefore to develop software applications independent of the equipment used, in particular to reduce development costs.

International application WO 2013/032660 describes an operating system composed of a plurality of basic operating systems and a master operating system. Each basic operating system, implemented by an associated processor of the execution platform, comprises a core implementing a TCP/IP communication protocol.

The master operating system is capable of breaking a task of a software application into a plurality of elementary processes and allocating the execution of each elementary process to one of the basic operating systems.

In particular, this operating system allows a gain in energy by putting on standby a processor whose basic operating system is not called upon to execute a process.

However, such an operating system requires a memory size that is too large, both in terms of storing instructions as well as the memory space needed during its execution, in order to equip a communicating sensor.

The invention therefore aims to meet these needs.

The object of the invention is an operating system for a sensor of a sensor network, characterized in that the operating system is configured to comprise, in addition to a plurality of generic system functionalities for the virtualization of the hardware resources of the sensor, in particular radiocommunication functionalities and routing functionalities, a plurality of application functionalities, wherein each functionality is defined by a software actor, and wherein each software actor is a finite state automaton, wherein the execution by the different software actors is defined in a predetermined scheduling sequence determining the temporal order of the call up of each actor during an execution cycle.

This operating system makes it possible to develop software applications on a generic sensor in order to configure it for a particular use. It also allows optimization of the energy consumption of the host sensor.

By its structure, it may be easily equipped with services to make the operation of the sensor reliable.

According to particular embodiments, the operating system may comprise one or more of the following characteristics, taken separately or in any technically feasible combination:
the operating system comprises a monitored logical actor and a monitoring logical actor for monitoring the monitored logical actor, wherein the monitored logical actor follows, during its nominal operation, a determined sequence of states, so that any deviation from the sequence of states is indicative of a malfunction of the monitored logical actor and leads to a transition of the monitoring actor to a state of reconfiguration of the monitored logical actor;
the transition to the reconfiguration state of the monitoring logical actor leads to the implementation of an action corresponding to a strategy for correcting the malfunction affecting the monitored logical actor;
at least one monitored logical actor is redundant through an equivalent logical actor, wherein the correction strategy consists in executing the equivalent logical actor in place of the monitored logical actor;
the sensor comprises at least two cores, a main core and a secondary core, wherein the execution of the system and application functionalities is distributed among the different cores according to a predefined distribution.
the operating system comprises a system functionality for power management executed on the main core and able to shut down the secondary core when this latter is inactive and to turn on the secondary core to run a functionality;
each logical actor is defined by a table of states comprising a plurality of lines, wherein each line comprises an initial state of the actor, an initial message, an action performed by the actor when it receives the initial message, a final state to which the actor switches when the action is performed, and a final message when the actor switches to the final state, wherein the binary code of the action is intended to be loaded in a storage means of the sensor in view of its execution by calculation means of the sensor;
the operating system comprises a table of current states making it possible to store the current state of each logical actor executed on the sensor.

The invention also relates to a communicating sensor integrating the operating system presented above.

The invention and its advantages will be better understood upon reading the following detailed description of a particular embodiment, given solely by way of nonlimiting example, wherein this description is made with reference to the appended drawings, wherein:

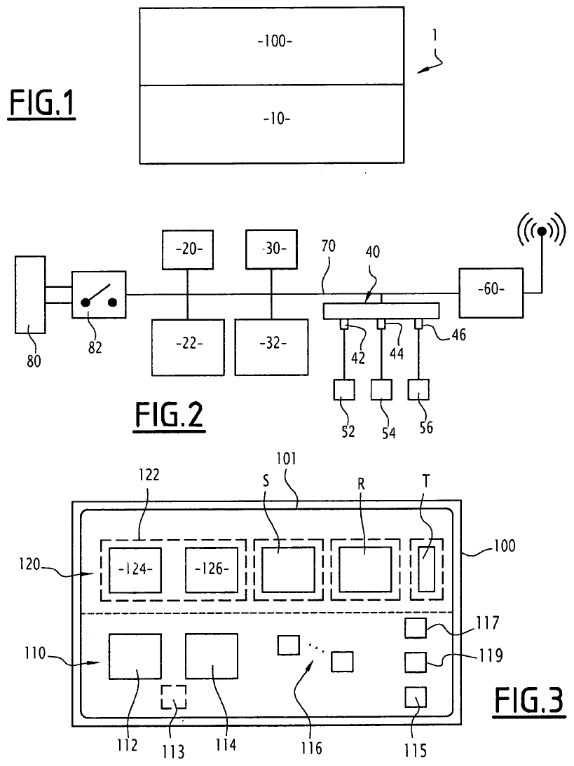

FIG. 1 shows a schematic representation of a generic sensor according to the invention;

FIG. 2 shows a schematic representation of an embodiment of the hardware layer of the sensor of FIG. 1;

FIG. 3 shows a schematic representation of the operating system according to the invention adapted to be executed on the sensor of FIG. 1;

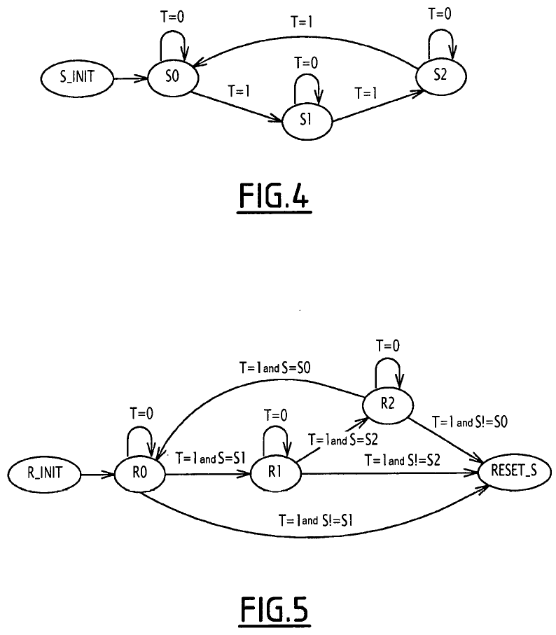

FIG. 4 shows a first software actor of the operating system of FIG. 3;

FIG. 5 shows a second software actor of the operating system of FIG. 3, monitoring the first software actor of FIG. 4.

Referring to FIG. 1, a sensor 1 constitutes each of the nodes of a sensor network.

The sensor 1 comprises a generic hardware layer 10 and a software layer 100.

Referring to FIG. 2, the material layer 10 comprises a calculation means, preferably consisting of several cores. For example, the hardware layer comprises two cores, a first core 20 consisting of a 4-bit nano-controller and a second core 30 consisting of an 8-bit AVR microcontroller. More preferably, the architecture of the hardware layer 10 is an asymmetrical ON/OFF multi-core, i.e. the second core 30 is completely turned off (OFF) by the first core 20 after executing the process for which it was turned ON. The first core 20 remains permanently on, even if it may be placed in a “sleep mode” to limit its energy consumption. The core 20 is called the main core and the, or each, other core, such as the core 30, is called the secondary core.

The hardware layer 10 comprises a storage means, comprising at least one memory. Preferably, as shown in FIG. 2, the sensor 1 comprises a first memory 22, associated with the first core 20, and a second memory 32, associated with the second core 30.

The hardware layer 10 has an input/output interface 40 with a plurality of physical ports, referenced 42, 44 and 46 in FIG. 2. Each port is connected to a detector, 52, 54 and 56 respectively, which may be of a different kind. In a variant, several detectors are connected to the same physical port, for example a port of the USB type.

The hardware layer 10 comprises a communication module, preferably a wireless module, such as a radio communication card 60, preferably of the Wi-Fi or IEEE 802.15.4 or NB-IoT or 3G/4G type.

The hardware layer 10 comprises a physical communication bus 70 connecting the different components to each other in order to allow the physical exchange of data.

The material layer 10 comprises a source of electrical power, making it possible for the sensor 1 to be autonomous. This may be, for example, a battery 80 consisting of one or more batteries. Alternatively, the battery may consist of one or more accumulators and may be associated with a power recovery module (also referred to as an “energy harvesting module”).

The hardware layer 10 also comprises controlled interrupt means 82 for the supply or stopping the supply of one or other component of the hardware layer.

As a variant, each component of the hardware layer may be made physically redundant by the presence of an identical component, capable of replacing the component in questions in case of failure. The bus 70 is then common to the redundant and replacing components.

The calculating means are suitable for executing the computer program instructions stored in the storage means. In particular, each core 20, 30 is able to execute the computer program instructions stored in the memory 22, 32 associated therewith.

Referring to FIG. 3, the software layer 100 comprises an operating system 101 configured to provide one or more software applications for configuring the sensor 1 on which the operating system 101 is executed.

The operating system 101 comprises a system layer 110 and an application layer 120.

The concept of a layer is only illustrative since the operating system 101 once it has been configured by the specification of one or more software applications, comprises a set of functionalities of the same level of execution.

According to the invention, each functionality is defined as a finite state machine, referred to as a logical actor in this document.

Each logical actor is defined by a finite set of possible states and by the permissible transitions from an initial state to a final state among the possible states.

More precisely, a logical actor is entirely defined by the data of a table of states comprising a plurality of lines, wherein each line comprises an initial state of the actor, an initial message, an action performed by the actor when it is placed in the initial state and receives the initial message, a final state to which the actor switches once the action is performed, and a final message generated by the actor when switched to the final state. The table of states may be aggregated together to form a single common general table saved in an operating system configuration file 101. In FIG. 3, such a general table is referenced by the number 115.

A message (also called a “flag”) is an indication of the current state of an actor. Thus, the initial message corresponds to the fact that a first actor has been placed in a given state, which has the effect of triggering the action of a second actor and the transition of this second actor from an initial state to a second final state. The final message sent by this second actor is then the final state to which it has just switched. Alternatively, a message may be a condition on a set of current states of actors.

The system layer 110 groups together a plurality of system functionalities, present in the generic operating system, prior to its configuration. These system functionalities allow the management of the hardware components of the sensor 1 (memory, processor, input/output interface connected to peripherals . . . ), as would a core. Among these system functionalities, there is a communication function 112, a routing function 114, virtualization functionalities of the physical ports of the input/output interface 40, referenced 116 in FIG. 3, and, advantageously, an energy management functionality 113.

The application layer 120 comprises all of the application functionalities developed to particularize the sensor 1. A complex software application is thus broken down into one or more basic application functionalities.

Thus, for example, an application 122 is composed of two specific functionalities 124 and 126, in addition to the possibility of using system functionalities, for example input/output. FIG. 3 also shows a monitored application comprising a single application functionality or logical agent S and an application monitoring the monitored application comprising a single application functionality or logical agent R, as well as a timeout application comprising a single application functionality or logical agent T.

The application layer 120 thus enables an operator to configure the operating system 101 to present, in addition to the system functionalities, a plurality of application functionalities defined in relation to the envisaged use of the sensor 1 using the operating system once configured.

A configuration tool is specifically provided to provide an operator with a man/machine interface for easy configuration of the operating system 101.

FIG. 4 represents an example of an application functionality S for acquiring a measurement, for example a measurement of temperature.

When executed, the logical actor S is first in an initialization state S INIT.

Then, once initialized, it switches to the state SO.

In the state SO, the actor S waits for the end of a sampling duration defined by a timeout actor T.

The timeout actor T is a two-state actor. In state 0, it checks at each execution cycle the value of a counter with respect to a maximum value (preferably this value is specific to each state of an actor). If the value of the counter is less than a maximum value, the value of the counter is incremented by one unit; if the value of the counter is equal to the maximum value, the actor T switches to state 1. In the state T=1, the counter is reset to zero and the actor T switches back to the state T=0.

The actor S in the state SO initializes a counter of the timeout actor T (which is then placed in the state T=0). The actor S waits to receive a message indicating that the timeout actor T is in the state 1 to read, at a determined virtual port which corresponds to a physical port of the input/output interface 40, a temperature signal generated by the sensor connected to this physical port. The actor S then switches to the state S1.

In the state S1, the actor S initializes a counter of the actor T (which is then placed in the state T=0). The actor S waits for the actor T to switch to the state T=1, in order to convert the read temperature signal into a temperature value. The actor S then switches to the state S2.

In the state S2, the actor S transmits the temperature measurement to the communication system actor 112 with a view to transmitting this temperature, measurement to the base station, via the sensor network and the Internet. At the same time, it initializes a counter of the timeout actor T to set the waiting time (“timeout”) of the acknowledgment of the transmission by the communication system actor 112. In the case where the counter has timed out and the actor S has not received the expected acknowledgment, it retransmits the same measurement again. Once the measurement is transmitted and the corresponding acknowledgment received, the actor S switches back to the state SO for the acquisition of the next measurement.

In another example, the measurement of the temperature thus acquired is transmitted to an actor control system of a fan equipping the sensor to cool the components, particularly the cores. This actor system generates a signal upon closing a switch of the controlled interruption means placed between the power source and the fan, as soon as the measurement exceeds a predefined threshold.

Once defined, the table of states of a logical actor is stored in the storage means associated with the main core. The states of all the application logical actors are advantageously defined in a common general table in order to facilitate the development and updating of this application.

The binary code of an actor is loaded into the memory associated with the core on which it is to be executed. The binary codes of the system actors are preferably loaded into the memory associated with the main core, while the binary code of each application actor is loaded into the memory of a core among the main core and the secondary cores.

The binary code of a state automaton is reduced. The configured operating system therefore has a low memory footprint.

The distribution of the actors by core is effected during the configuration of the sensor 1 by the operator by means of the man/machine configuration interface made available to it.

The system and application actors are, in particular, distributed over the different cores according to the execution constraints of an application. In the simple case, all the actors are executed by a single core (low cost system without reliability constraints). However, the actors of an application or the operating system may be distributed over several cores in an appropriate manner, on the one hand to minimize energy consumption and, on the other hand, to mitigate failures in case of a malfunction.

An application may call up a system functionality in order to require the execution of the corresponding system functionality. For example, the transmission of data to the communication card for transmission over the network is an example of such a system function called up by an application.

The operating system provides a library of system actors. The corresponding system functionalities make it possible to simplify the programming of the actions that may be performed by an application actor.

Those skilled in the art will find that the application actors and the system actors are strongly coupled (tight cross layering) and have the same rights during their execution (an application actor has the same rights as a system actor). This is the reason why it may be said that the application layer 110 is in the operating system 101. In particular, there is no change of context when switching between the execution of a system actor and that of an application actor.

Unlike a conventional core of the prior art, the operating system 101 does not comprise a scheduling service to orchestrate the execution of system or application logical actors. During the development of an application and therefore of the configuration of the generic operating system, the operator schedules the order of execution of the actors according to a scheduling sequence 117 saved in an operating system configuration file. At each execution cycle, the logical actors are successively called according to the scheduling sequence.

The execution of the scheduling sequence is based on a table which comprises, for each actor in progress, the current state in which it is present.

This table of current states is stored in the memory of the main core 20. It is shown schematically in FIG. 3 and has the reference 119.

Upon calling up an actor, the table of current states is consulted to determine whether the conditions defined by the initial message associated with the current state of the actor in question are verified. If so, the action associated with the current state of the actor is performed and a transition allows the actor in question be switched to the final state. The latter switches to a new state and indicates it by an adapted final message, i.e. by updating its current state in the table of current states.

If an initial message is developed from the states of two other actors, it is appropriate to break down this initial message into a logical expression comprising, for example, an “AND” operator that is able to aggregate the two states to develop the initial message of the actor in question.

Advantageously, an energy management system actor 113 scans the states of the actors executed on the same secondary core 30. When all these actors are in a state of rest or of completion, the actor 113 turns off the corresponding secondary core, for example by appropriately controlling the controlled interruption means 82.

Advantageously, the energy management system actor 113 scans the states of the actors executed on the main core 20. When all these actors are in a state of rest or of completion, the actor 113 puts the main core, i.e. the sensor, to sleep.

These actions limit the energy consumption of the sensor and therefore increase its life in the case where it is equipped with a non-rechargeable battery.

In general, the nominal execution of a logical actor is performed according to a predefined sequence of states.

Consequently, any deviation from this predefined sequence of states is indicative of a malfunction. The monitoring of the sequence of states followed by a logical actor during its execution thus makes it possible to identify the occurrence of a malfunction and to implement a corrective action designed to maintain the corresponding functionality.

For this, it is planned to associate, for example with each system or application logical actor, a monitoring logical actor. Alternatively, and depending on the constraints, a single monitoring logical actor may be set up to monitor the functioning of all actors, including system actors in a transparent manner.

FIG. 5 thus shows a monitoring actor R of the logical actor S of FIG. 4.

At each cycle, the monitoring actor R is executed following the execution of the monitored actor S.

The monitoring actor R is initialized during the initialization S INIT of the actor S.

After an initialization phase R_INIT following the initialization of the actor S, the monitoring actor R is placed in the state RO.

In the execution cycle in which the timeout actor T switches from the state T=0 to the state T=1, the monitored actor S performs the action of the state SO and toggles the state SO to the state S1. Then, the actor R, in the state RO, is called up: determining, according to the table of the current states, that the actor T is in the state T=1 and that the actor S is in the state S=S1, wherein the monitoring actor R then switches to the state R1.

On the other hand, if the actor T is in the state T=1 and the actor S is in a state other than the state S1, S!=S1, the monitoring actor R switches to the state of reconfiguration of the monitored actor, RESET_S.

At the next execution cycle, as the actor T is in the state T=1, the value of the counter is reset and the actor T switches to the state 0. If the actor R is in the state RESET_S, the associated action is executed as will be shown below.

Then, in the cycle in which the timeout actor T switches again from the state T=0 to the state T=1, the monitored actor S executes the action of the state S1 and switches to the state $2. Then, the actor R, in the state R1, is called up: determining, according to the table of the current states, that the actor T is in the state T=1 and that the actor S is in the state S2, S=S2, the monitoring actor R switches to state R2.

On the other hand, if the actor T is in the state T=1 and the actor S is in a state other than the state S2, S!=S2, the monitoring actor R switches to the state of reconfiguration of the monitored actor, RESET_S.

At the next execution cycle, as the actor T is in the state T=1, the value of the counter is reset and the actor T switches to the state 0. If the actor R is in the state RESET_S, the associated action is executed as will be shown below.

In the cycle in which the timeout actor T switches again from the state T=0 to the state T=1, the monitored actor S executes the action of the state S2 and switches to the state SO. Then, the actor R, in the state R2, is called up: determining, according to the table of the current states, that the actor T is in the state T=1 and that the actor S is in the state SO, S=SO, the monitoring actor R switches to the state RO.

On the other hand, if the actor T is in the state T=1 and the actor S is in a state other than the state SO, S!=SO, the monitoring actor R switches to the state of reconfiguration of the monitored actor, RESET_S.

At the next execution cycle, as the actor T is in the state T=1, the value of the counter is reset and the actor T switches to the state 0. If the actor R is in the state RESET_S, the associated action is executed as will be shown below.

It can be seen that the monitoring actor R switches to the state RESET_S when the monitored actor S can not properly perform the action associated with its current state. This is a priori caused by a malfunction. In this example, the fault detection is similar to so-called “watchdog” or “heartbeat” mechanisms.

Once a fault has been detected, it may be answered by the action associated with the RESET_S status of the monitoring actor R. This reconfiguration action is defined by the operator during the configuration of the operating system 101.

It may, for example, be to implement a predefined strategy to allow the sensor 1 to again have the functionality associated with the defective monitored actor. For example, in a strategy of redundancy of the logical actors, the monitoring actor R starts the execution of a software actor equivalent to the defective actor S, preferably on another core of the sensor.

The monitoring actor R is advantageously executed on the main core 20 while the monitored actor S, for example the measurement acquisition actor, is executed on a secondary core 30.

Thus, the configurable operating system according to the invention makes it possible to develop and control a robust and reliable sensor. In fact, it makes it possible to detect transient and permanent errors based on a nominal sequence of states for each of the logical actors used for each sensor functionality. The redundancy of the components and the use of equivalent actors allow a correction of the errors detected. The sensor executing the operating system is therefore robust.

It should be noted that the fact that a defective actor may be replaced by an equivalent actor, also called temporal redundancy or cold redundancy, avoids having to implement hot redundancy mechanisms, wherein several similar actors are executed simultaneously and a polling mechanism verifies that the outputs of these different actors are coherent with each other. Such hot redundancy does not correspond to the objectives of limiting the memory footprint and saving energy.

The sensor on which the operating system is executed is called up to form a node of an ad hoc communication network. For routing a data packet from a source node to a destination node (e.g. connected to the Internet), the data packet is transmitted from one node to a neighboring node, wherein each intermediate node acts as a relay of the data packet.

To know to which neighboring node a packet must be sent to reach a destination node, the node in question must implement an appropriate routing service.

Such a routing service is based on the knowledge, by the considered node, of the topology of the network. This knowledge is summarized in a routing table stored in the memory of the sensor node.

Many ways of routing are known. In the operating system according to the invention, the routing functionality is based on the relative position of the network sensors. It exploits the power of the signal received by the neighboring sensors (“RSSI” according to the acronym “Received Signal Strength Indication”), as measured by the radiocommunication module equipping the card 60.

The address of a sensor is, for example, encoded on 11 bits. The number of bits may be increased to increase the accuracy of the address and thus the knowledge of the position of the sensor without changing the operating principle of this routing.

The different fields of an address are: 4 bits for a region identifier; 4 bits for a hop count; and 3 bits for a sensor identifier.

The positions of the sensors are indicated in a horizontal plane. A sensor is chosen as the coordinating sensor and constitutes the origin of the plane. In addition, at least three reference sensors are put in place before all the other sensors. The reference sensors in combination with the coordinator sensor make it possible to define directions in the plane and delimit geographical angular sectors therein.

The fixed ad hoc network sensors are deployed from the coordinator sensor, one by one, towards the outside. During the deployment, all sensors are active. The address of a sensor is then determined at the time of deployment of this sensor.

The region identifier indicates the geographic angular sector where a sensor is located. Thus, with four bits, one can identify sixteen sectors in the plane.

The number of hops indicates the distance (in the number of hops) that separates the sensor in question from the coordinating sensor.

The sensor identifier is assigned by the coordinating sensor to ensure the uniqueness of the address of a sensor in a sector. Being coded on three bits, each sector may thus contain eight sensors.

With respect to a routing function based on the geographical position of the sensor, for example using its position determined by means of a satellite constellation, such as the GPS system for example, the present routing functionality is less accurate but can work both indoors and outdoors, without additional energy costs. Compared to a Routing Protocol for Low Power and Lossy Networks (RPL) routing service, which is IETF standard, this routing functionality is more flexible and consumes less power and is suitable for sensor networks.

The geographical position of the sensor is then used as the address of the sensor on the network. This concept makes it possible to minimize the size of the data packets and to know the origin of data, i.e. which sensor is at the origin of the acquisition of this data. It should be noted that the conventional routing technique requires the address of the sensor on the network as well as its geographical position. This results in an increase in the size of the data packets and therefore the size of the memory of each sensor to store a routing table of suitable size.

In addition, since this routing functionality is composed of system actors, its operation may be easily monitored by one or more associated monitoring agents. Wireless communication failures can thus be monitored and strategies may possibly be provided to address them.

Tests were conducted in order to quantitatively compare the robustness of the proposed solution compared to the prior art.

For this, a card for a communicating sensor according to the IEEE 802.15.4 protocol (also called “ZigBee” protocol) was developed using the ATMEGA128RF 8-bit microcontroller from ATMEL.

With this microcontroller, the company ATMEL provides the proprietary operating system “BitCloud”.

Fifty identical cards were made. Two sets of tests were then designed, wherein each batch comprised five randomly chosen cards from the fifty cards produced.

The cards of a first batch work with the operating system based on state automatons according to the invention, while the cards of a second batch work with the proprietary operating system delivered by the company ATMEL. Incidentally, the operating system according to the invention used 9 kb of “Flash” memory while the proprietary operating system of the company ATMEL required 100 kb of “Flash” memory.

Each sensor performs the same tasks: acquisition of data from a temperature sensor and a brightness sensor. The five sensors form between them a network having a star topology, comprising a coordinator node connected to a personal computer and four terminal nodes in communication with the coordinator node. The data delivered by the sensor probes are recorded in a database of the personal computer.

More than six million records were made over two and a half years. The network consisting of the cards of the first batch was running continuously for two and a half years, without any fatal failure, i.e. without a failure having led to the shutdown of one of the network's sensors, although non-fatal failures that required automatic reconfiguration of a sensor so that it could continue its operation might have occurred.

On the other hand, the network consisting of the cards of the second batch experienced numerous failures. The average duration without fatal failure was actually very short, less than ten days.

The operating system based on state automatons according to the invention is therefore much more robust than the operating systems of the prior art.

1. Operating system for a sensor of a sensor network, wherein the operating system is configured to comprise, in addition to a plurality of system functionalities for virtualizing the sensor hardware resources, in particular radio-communication functionalities and routing functionalities, a plurality of application functionalities, wherein each system or application functionality is defined by a software actor, wherein each software actor is a finite state automaton, wherein executing the different actors is defined in a predetermined scheduling sequence determining a temporal order for calling up each actor during an execution cycle.

2. Operating system according to claim 1, comprising a monitored logical actor and a monitoring logical actor for monitoring the monitored logical actor, wherein the monitored logical actor, during its-nominal operation thereof, follows a determined sequence of states, so that any deviation from the sequence of states is indicative of a malfunction of the monitored logical actor and leads to a transition of the monitoring logical actor to a state of reconfiguration of the monitored logical actor.

3. Operating system according to claim 2, wherein the transition of the monitoring logical actor to the state of reconfiguration of the leads to the implementation of an action corresponding to a strategy for correcting the malfunction affecting the monitored logical actor.

4. The operating system according to claim 3, wherein at least one monitored logical actor is redunded by an equivalent logical actor, wherein the strategy for correcting the malfunction affecting the monitored logical actor consists in executing the equivalent logical actor in place of the monitored logical actor.

5. Operating system according to claim 1, wherein the sensor comprises at least two cores, a main core and a secondary core, and wherein an execution of the system and application functionalities is distributed among the main and secondary cores according to a predefined distribution.

6. Operating system according to claim 5, wherein the operating system includes a system functionality for power management executed on the main core and adapted to turn off the secondary core when this latter is inactive and to turn on the secondary core to execute a system or application functionality.

7. Operating system according to claim 1, wherein each logical actor is defined by a table of states comprising a plurality of lines, wherein each line comprises an initial state of the logical actor, an initial message, an action performed by the logical actor when it receiving the initial message, a final state to which the logical actor switches once the action is performed, and a final message when the logical actor switches to the final state, wherein the binary code of the action is designed to be loaded into a storage means of the sensor for execution by a calculation means of the sensor.

8. Operating system according to claim 1, comprising a table of current states for storing the current state of each logical actor executed on the sensor.

9. Sensor comprising a hardware layer and a software layer, wherein the software layer comprises an operating system according to claim 1.
